(19) United States
(12) Patent Application Publication
(10) Pub. No.: US 2004/0136819 A1
(43) Pub. Date: Jul. 15, 2004

(54) Load handling system with reduced overhead clearance

(76) Inventors: John Hummel, Florissant, MO (US); Joseph H. Cox JR., Town ?amp; Country, MO (US)

Correspondence Address: LEWIS, RICE & FINGERSH, LC, ATTN: BOX IP DEPT., 500 NORTH BROADWAY, SUITE 2000, ST LOUIS, MO, 63102, US

(21) Appl. No.: 10/685,122

(22) Filed: Oct. 14, 2003

Related U.S. Application Data
(60) Provisional application No. 60/417,834, filed on Oct. 11, 2002.

(51) Int. Cl. B60P 1/64

(52) U.S. Cl. 414/498

(57) ABSTRACT

A load handling systems for manipulating a load onto and off of a vehicle, which moves the load about three axes of rotation during the loading and unloading process and which does not reversibly engage the vehicle. An embodiment is a load handling system that includes three support arms pivotally attached and serially disposed, the support arms being controllably rotated relative to one another by lift mechanisms in a manner that moves a connector for connecting the load handling system to the load about three axes of rotation as it moves from a transit position to a load-disengaging position.

### CROSS-REFERENCE TO RELATED APPLICATIONS

This application claims the benefit of U.S. Provisional Application No. 60/417,834, filed Oct. 11, 2002, the entire disclosure of which is herein incorporated by reference.

### STATEMENT REGARDING FEDERALLY SPONSORED RESEARCH OR DEVELOPMENT

The work leading to this invention may have been supported in part by the United States Army, TACOM-ARDEC, AMSTA-AR-PC, Picatinny Arsenel, N.J. 07806-5000, Contract #DAAE30-02-C-1090. The United States government, therefore, may have certain rights in this invention.

### BACKGROUND OF THE INVENTION

1. Field of the Invention

The invention concerns a load handling system comprising a mechanical linkage of support arms and mechanisms for moving these support arms, such system to be mounted on a truck, a trailer, or more generally any vehicle. The system is designed to manipulate a pallet, a container, or more generally any voluminous load, particularly for bringing the load onto or removing the load from the vehicle, the action of the system being generally arcuate in nature.

2. Description of the Prior Art

Load handling systems (“LHSs”) generally have been used in numerous applications, including the loading and unloading particularly of trucks used for carriage of refuse containers, smaller vehicles such as snowmobiles, and tall structures such as silos. The LHSs generally move between two primary positions, one for transit wherein the LHS is collapsed generally close to the vehicle and another for initial engagement with the load wherein the LHS is generally extended above and behind the vehicle. The motion of the LHS is generally arcuate, and is described equivalently in this disclosure as pivoting and rotating.

An example of a fairly simply LHS is a system referred to herein as a basic LHS, which is described as follows. The basic LHS generally comprises two support arms, a front support arm and a rear support arm, each pivotally connected to the other at one end, the rear support arm being also pivotally connected at an opposite end to the vehicle near the rear of the vehicle, and a lifting mechanism disposed between the vehicle and the front support arm. In the transit position the support arms are disposed generally parallel to the vehicle chassis except for an extension of the front support arm that rises generally perpendicular thereto, and which is disposed toward the front of the front support arm. Commonly, the perpendicular projection of the front support arms is the primary point of attachment to the load. The unloading process comprises an extension of the lifting mechanism, raising the front support arm (including the perpendicular projection) and, thus, the load in an arcuate motion as the front support arm rotates about its pivoting connection to the rear support arm to a position where a portion of the front support arm abuts a portion of the rear support arm. After the front support arm contacts the rear support arm, as the lifting mechanism continues to extend, the front support arm no longer rotates relative to the rear support arm, but the rear support arm begins to rotate about its pivoting connection to the vehicle, likely passing through a vertical position to a final, unloading position such that the load has been moved about the two axes upward and rearward then downward and rearward until the load is placed on the ground behind the vehicle. One such LHS is disclosed in U.S. Pat. No. 3,878,948, the entire disclosure of which is incorporated herein by reference. Other embodiments of prior art LHSs may comprise a greater number of lifting mechanisms and more complex support arms. One such embodiment is used in military transport operations.

Militaries around the world use a wide variety of different transport vehicles for getting large quantities of diverse materials needed for effective combat operations from the plants or factories where those materials are manufactured, or from other positional sites for deployment, to the point where those materials are consumed. They, thus, support a broad range of operations. One of the most critical materials that needs to be transported is ammunition. Ammunition is, however, difficult to transport because it is usually strangely shaped, heavy, and explosive. In combat operations, these factors can lead to numerous logistical problems in getting ammunition from the manufacturer to the soldier in the field. For instance, the ammunition will often need to be transported by aircraft to reach a distant theater, but usually transport aircraft cannot land at the forward edge of the battle area or other similar points where the ammunition is most needed. Instead, specialty trucks usually move the material from the aircraft landing area to an Ammunition Supply Point (ASP) where it can be distributed to combat forces.

Traditionally, the transport in aircraft of materials such as ammunition has been accomplished using specially constructed pallets generally referred to as 463L pallets (United States Air Force part number 98752 or identifying numbers NAS1921-B06-504, NAS 1399D64A, and/or NAS 1721H6-4F). These pallets are of standard shape and size for loading and securing in the aircraft through locking rail systems. They are specifically designed to be very strong for their weight.

On the other hand, the pallets used by transport trucks to carry things such as ammunition have traditionally been of a different design that is larger and more rugged because trucks are not as dependent on weight limits as are aircraft. Regardless of the type of truck used, generally the objects being carried by these trucks are placed on pallets referred to as “skids,” “flatracks,” or “Container Roll-in/Out Platforms (CROPs),” such an unloaded pallet (113) is shown in FIG. 1. Embodiments of these pallets are disclosed in U.S. Pat. No. 4,911,318 and U.S. Pat. No. 5,799,585, the entire disclosures of which are incorporated herein by reference.

In particular, the transport of pallets by truck is generally performed by trucks with overhead hook loading systems, generally called Platform Load/unload Systems (PLS), the trucks generally termed PLS trucks. One truck that may be mounted with a PLS system is a Heavy Expanded Mobility Tactical Truck (HEMTT). HEMTTs using such systems are generally referred to as LHS or HEMTT-LHS trucks. An example of a prior art HEMTT-LHS is shown in FIG. 1 and FIG. 2. A HEMTT-LHS as an example of a more complex LHS as compared with the basic LHS described above.

That trucks and aircraft have made use of different pallet systems has been a significant cause of inefficiency in material transport. As one step to remedy this inefficiency, pallet systems have been designed that are suitable for use in both aircraft and on trucks so that the transfer of materials from one pallet to another when switching modes of transportation has been eliminated. Such specially designed pallets systems are described in other documents, including U.S. Utility patent applications Ser. No. 10/462,382 and No. 10/635,239, the entire disclosures of which are herein incorporated by reference. Notwithstanding the new pallet design, inefficiencies have remained in the material transport process because traditional prior art PLS and HEMTT-LHS trucks have been unable to load the new pallets directly onto some types of aircraft due to physical interferences caused by the geometry of the truck, LHS, and aircraft. Thus, some transfers of palleted materials between trucks and aircraft have still required the use of a third vehicle.

The problem just presented is illustrated in FIG. 2, which depicts a prior art HEMTT-LHS truck (109) attempting to load a pallet onto a C-130 aircraft (199). A significant problem for operation of the HEMTT-LHS in this application is that the path of the LHS through the elevated arc (51) intersects the body of the aircraft. Because of the configuration of the LHS, the load, and the truck, the load cannot be disconnected from the LHS in any position prior to or at the point of intersection. Such disconnection would not be advantageous, at any rate, because it would not allow for achievement of the goal of using the LHS to complete the transfer of the load from the truck into the aircraft. Therefore, it is observed that an attempt to complete the removal of the load from the truck onto and into the aircraft would be frustrated by an impact of the LHS with the aircraft.

Like the basic LHS described above, the HEMTT-LHS generally moves between two primary positions, one for transit wherein the LHS is collapsed generally close to the vehicle (109) and another for initial engagement or disengagement with the load wherein the LHS is generally extended above and behind the vehicle. Operation of the traditional prior art PLS or HEMTT-LHS systems has significant similarity to the operation of the basic LHS described above but utilizes a second lifting mechanism disposed between the two support arms. As compared with the basic LHS described above in which the rear support arm did not operate until engaged by the front support arm, inclusion of the second lifting mechanism in the prior art HEMTT-LHS allows for variation in the angle between the two support arms while the LHS is in operation, i.e., inclusion of the second lifting mechanism allows the rear support arm to move independently of the movement of the front support arm.

A HEMTT-LHS near the disengagement position is shown in FIG. 1. The prior art HEMTT-LHS comprises two support arms, a front support arm (105) and a rear support arm (107), pivotally connected at a front pivoting connection (175) fixed at a position between the front end (157) and the rear end (159) of the rear support arm (107), the rear support arm (107) being pivotally connected to the vehicle (109) at the rear pivoting connection (179), fixed in a position near the rear of the vehicle (109), a rear lifting mechanism (195) disposed between the vehicle (109) and the rear support arm (107), and a front lifting mechanism (193) disposed between the two support arms. In the transit position the support arms (105 and 107) are disposed generally parallel to the vehicle (109) except for distal length (103) of the front support arm (105) that is rigidly fixed in a configuration such that the distal length (103) rises generally perpendicular to the proximal length (104) of the front support arm (105) and is disposed near the front end (133) of the proximal length (104), the distal length (103) comprising the primary point of attachment between the LHS and the load. The front support arm (105), then, is of a rigid “L” shape, the proximal length (104) disposed generally parallel to the truck (109) when in the transit position, the distal length (103) generally perpendicular thereto.

The unloading process initially comprises an extending of the front lifting mechanism (193) to lift the front support arm (105) in an arcuate motion about the front pivoting connection (175). As the front support arm (105) is lifted, so, too, is the load, which rests on the pallet (113) that is connected via the hook (101) to the distal length (103) of the front support arm (105). At some time after the front lifting mechanism (193) begins extending, the rear lifting mechanism (195) begins to extend, rotating the rear support arm (107) about the rear pivoting connection (179). As the rear lifting mechanism (195) begins its action, the front lifting mechanism (193) may or may not have stopped acting. One or both lifting mechanisms (193 and 195) act until the support arms (105 and 107) reach the unloading position whereby the load has been moved about the two transverse axes possibly through the front pivoting connection (175) and the rear pivoting connection (179), moving generally upward and rearward then downward and rearward until the load is placed on the ground behind the vehicle.

### SUMMARY OF EMBODIMENTS OF THE INVENTION

A significant problem in the prior art that is addressed by the present invention is summarized by stating that the prior art LHSs generally operate to load and unload a vehicle by substantial rotation of the load about two primary axes accomplishing what is fundamentally an essentially horizontal displacement of the load toward the rear of the vehicle by traversing an arcuate path of relatively great elevation. Thus, prior art LHSs generally require significant clearance above the vehicle to perform the loading and unloading process. Of course, the clearance required is dependent upon and, therefore, must be considered relative to the dimensions of the particular LHS involved. Still, the highest elevation of the arc through which the load is moved during loading or unloading may be reduced by substituting, in place of a prior art LHS, a similarly dimensioned LHS embodying the present invention.

While embodiments of the present invention may operate on similar principles to the prior art, it achieves its advantages through the use of additional controllably driven support arms providing additional axes of rotation. Just as with the description of the prior art, the motion of the LHS is generally arcuate, and is described equivalently in this disclosure as pivoting and rotating. By comparison to the embodiments of the prior art HEMTT-LHS described above, an embodiment of the present invention can be conceptualized as a load handling system that enables controllably altering the angle of attachment between what was in the prior art HEMTT-LHS the vertical extension portion (103) of the front support arm (105) and the other (horizontal) portion of that front support arm. In other words, in an embodiment of the present invention, the two portions of the front support arm of the prior art are no longer configured in a rigid “L” but are pivotally connected and controllably driven. Controllably altering the angle between the two portions of the front support arm of the prior art during operation allows the load to be moved rearwards of the vehicle (109) without causing it to be elevated from the vehicle (109) as high as is required when the vertical extension (103) of the front support arm (105) is rigidly held perpendicular to the other (horizontal) portion of that arm.

More generally, embodiments of the invention encompass an LHS comprising a connector for connecting the LHS to the load, at least three axes about which the connector moves relative to the vehicle during loading and unloading, and at least one support arm fixedly connected to the vehicle, wherein the support arm fixedly connected to the vehicle remains connected to the vehicle throughout the loading and unloading process, and is not required to reversibly engage the vehicle as a prerequisite for enabling said connector to move about three axes relative to the vehicle during loading and unloading. Such an LHS may further comprise at least one lift mechanism.

Other embodiments of the invention encompass LHSs as described in the previous paragraph that further comprise a plurality of support arms and lift mechanisms configured as described here. A first support arm having a first end and a second end is attached to the connector for linking the load handling system to a load, which is disposed near the first end of the first support arm. A second support arm having a first end and a second end is pivotally connected at its first end to the first support arm at a point between the ends of the first support arm. The second support arm is also pivotally connected at its second end to a last support arm. A last support arm having a first and second end is pivotally connected to the vehicle, and is pivotally connected to the second support arm at a point on the last support arm between its first and second ends. A first lift mechanism having a first end and a second end is pivotally connected by its first end to the first support arm at a position near to the second end of the first support arm, and is pivotally connected by its second end to the second support arm at a position between the first and second ends of the second support arm. This first lift mechanism is capable of rotating the first support arm with respect to the second support arm. A second lift mechanism having a first end and a second end is pivotally connected by its first end to the second support arm at a position near to the first end of the second support arm, and is pivotally connected by its second end to the last support arm at a position near to the first end of the last support arm. This second lift mechanism is capable of rotating the second support arm with respect to the last support arm. A last lift mechanism having a first end and a second end is pivotally connected by its first end to the last support arm at a position between the first and second ends of said last support arm, and is pivotally connected by its second end to the vehicle. This last lift mechanism is capable of rotating the last support arm with respect to the vehicle. In all embodiments having a for connecting the LHS to the load, the connector includes a hook, a clamp, a strap, a chain, or a magnet. As well, in all embodiments having a lift mechanism for moving the support arms, the lift mechanism includes a hydraulic actuator, a pneumatic actuator, or a screw-type actuator. Particularly for a military application, in an embodiment the vehicle is a Heavy Expanded Mobility Tactical Truck (HEMTT).

Another manner for describing an embodiment of the present invention is to focus on the position of the support arms and their pivoting connections. In this manner an embodiment encompasses a vehicle having a front end, a rear end, and an attached LHS, wherein the LHS comprises the following components including the described relationships. At least three support arms are generally serially disposed so that there is a first support arm, a second support arm, and a last support arm. Each of these support arms are pivotally connected with a support arm next adjacent in the series, and the last support arm is pivotally connected to the vehicle. In this manner of description, an embodiment has a transit configuration for carrying the load when the vehicle is in motion, the transit configuration being such that the pivotal connection between one of the support arms and a next adjacent support arm—a support arm next closer in the series to the last support arm—is at a position relative to the vehicle no closer to the rear end of the vehicle than is the position of the pivotal connection between the next adjacent support arm and the support arm that is next closer in the series to the last support arm as compared to this next adjacent support arm. The position of the pivotal connection between the next-to-the-last support arm and the last support arm is at a position relative to the vehicle no closer to the rear end of the vehicle than is the position of the pivotal connection between the last support arm and the vehicle.

Alternate embodiments encompass LHSs as described in the previous paragraph that further comprise the following components and relationships. In an embodiment the LHS has, in addition to the serially disposed support arms described above, a connector for connecting the load handling system to the load, and at least three axes about which the connector moves relative to the vehicle during loading and unloading. In this embodiment these axes correspond to pivotal connections between next adjacent support arms and to a pivotal connection between a support arm and the vehicle. Here, the transit configuration of the LHS is such that these axes are serially disposed such that a first axis that corresponds to the pivotal connection between one of the support arms and the next adjacent support arm closer in the series to the last support arm has a pivotal-connection-crossing position, i.e., a position at a point on the first axis where said first axis crosses through the corresponding pivotal connection, that is no closer to the rear end of the vehicle than is the pivotal-connection-crossing position of a second axis corresponding to the pivotal connection between the next adjacent support arm and the support arm that is next closer in the series to the last support arm as compared to the next adjacent support arm. Also in this embodiment, the pivotal-connection-crossing position of an axis corresponding to the pivotal connection between the next-to-the-last support arm and the last support arm is at a position relative to the vehicle no closer to the rear end of the vehicle than is the pivotal-connection-crossing position of an axis corresponding to the pivotal connection between the last support arm and the vehicle. Another embodiment, more specifically described with respect to the serial disposition of the support arms and lift mechanisms, includes an LHS as described in this paragraph, but that includes the support arm and lift mechanism arrangement that is described above in paragraph 018.

A further embodiment of the invention is a kit for converting a vehicle having a prior art LHS that raises a load to a first lowest maximum elevation during loading and unloading to a vehicle having a reconfigured LHS—in this case, an LHS embodying the present invention—that raises said load to a second lowest maximum elevation during loading and unloading, wherein this second lowest maximum elevation is lower than the first lowest maximum elevation. The reconfigured LHS embodying the present invention may be described by any of the sets of limitations used in the above paragraphs. For an LHS that can be operated to move between a transit configuration and a load-disengaging configuration by several different paths, there may be various maximum elevations reached by the LHS along these different paths. The lowest maximum elevation is the highest elevation along the loading and unloading path that is lower than any other maximum elevation along any other loading and unloading path traversed by a single LHS operating through different paths.

Additionally, an embodiment of the present invention is a method of manipulating a load with respect to a vehicle comprising providing an LHS as described by any of the above sets of limitations to encompass the present invention, and using that LHS to manipulate the load connected to the connector. More specifically an embodiment of the invention is a method of providing an LHS as described by any of the above sets of limitations to encompass the present invention, and using that LHS to move a load from a vehicle to an aircraft or visa versa. Most specifically, an embodiment of the invention is such a method where the load moves directly from the vehicle to the aircraft or visa versa.

In all embodiments having a connector for connecting the load handling system to the load, the connector includes a hook, a clamp, a strap, a chain, or a magnet. And in all embodiments having a lift mechanism, the lift mechanism includes a hydraulic actuator, a pneumatic actuator, or a screw-type actuator.

One advantage of these embodiments is to allow a load to be loaded onto and unloaded from the vehicle utilizing a reduced elevation as compared to a prior art LHS of similar dimensions. The method of loading and unloading using an embodiment of the disclosed invention allows for its operation particularly under circumstances where there is a height restriction such as where loading or unloading occurs under a structure that protrudes above the vehicle that would otherwise frustrate operation of a prior art LHS of similar dimensions. As well, these embodiments allow the load to be loaded onto and unloaded from the vehicle without raising the load to as great an angle with respect to the vehicle chassis, thus generally decreasing the component force of gravity acting to displace the load from its desired position.

### BRIEF DESCRIPTION OF THE DRAWINGS

FIG. 1 shows a prior art Heavy Expanded Mobility Tactical Truck-Load Handling System (HEMTT-LHS) in an extended unloading position.

FIG. 2 shows a prior art HEMTT-LHS truck impacting a C-130 aircraft while attempting to unload a pallet from the truck onto the aircraft.

FIGS. 3 through 7 show time-lapsed frames of an LHS representing an embodiment of the present invention attached to a HEMTT truck loading a C-130 aircraft.

### DETAILED DESCRIPTION OF PREFERRED EMBODIMENTS

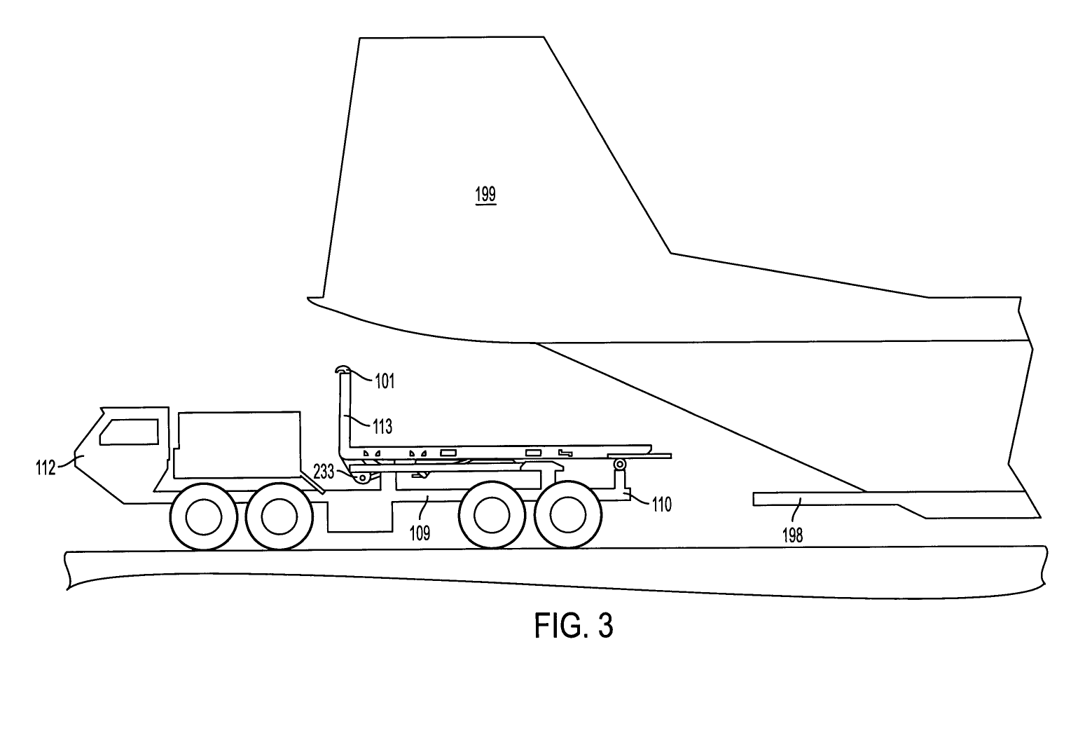

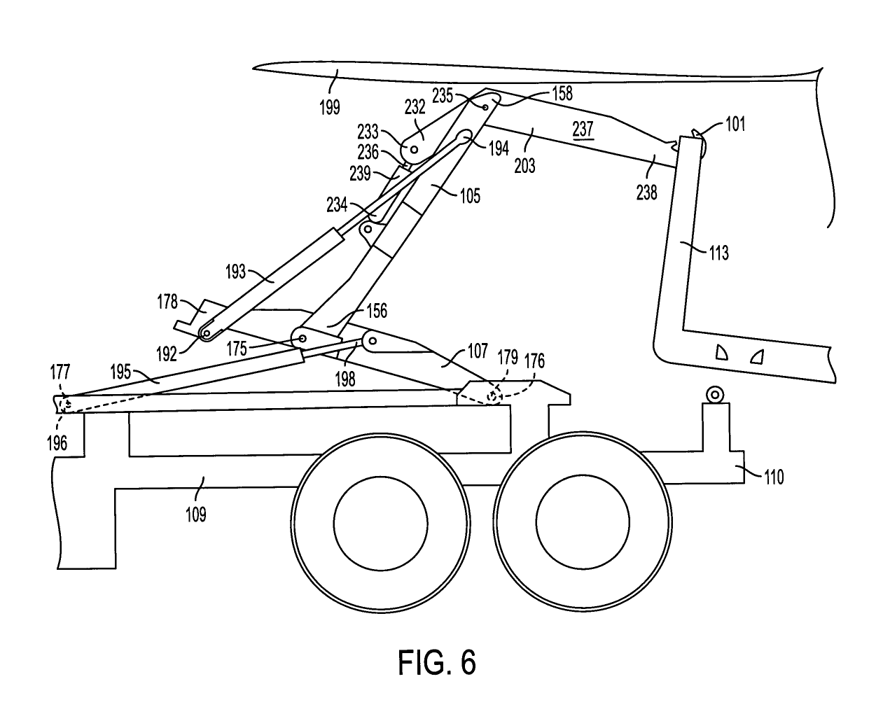

In an embodiment, the load handling system disclosed comprises the elements described below and labeled according to the numbers in FIGS. 3 through 7. An embodiment is shown in FIG. 3 in the transit position, the vehicle parked near an aircraft, the system ready for unloading. The components of the LHS and their relationships to one another are probably best viewed in FIG. 6, which depicts an embodiment in a state of partial extension during the unloading process.

The LHS of the depicted embodiment has three support arms (203, 105, and 107), each having a first and second end. At the first end (238) of the first support arm (203) is rigidly attached a hook (101), which is a connector for linking the LHS and the load. In alternate embodiments the connector may be any of a hook, a clamp, a strap, a chain, and a magnet. The first support arm (203) is rotationally connected between its first end (238) and second end (233) to the first end (158) of the second support arm (105) at a first support arm pivot (235). The rotational connection allows the first support arm (203) to rotate relative to the second support arm (105) about the first support arm pivot (235). Rotation of the first support arm (203) relative to the second support arm (105) is achieved preferably through the action of a first lift mechanism (239) that preferably has a first end (236) and second end (234) and is pivotally attached at its first end (236) to the second end (233) of the first support arm (203) and at its second end (234) to the second support arm (105) at a position between the first end (158) and second end (156) thereof. The first lift mechanism (239) may be a hydraulic, pneumatic, or screw-type lift mechanism, or other mechanism able to controllably rotate the first support arm (203) relative to the second support arm (105). In this embodiment, a second length (232) of the first support arm (203) extends beyond the pivoting connection between the first support arm (203) and the second support arm (105), but alternative configurations of the first support arm (203) are encompassed by the invention.

The second support arm (105) is rotationally connected at its second end (156) to the last support arm (107) at a second support arm pivot (175) located between the first end (178) and second end (176) of the last support arm (107). The rotational connection allows the second support arm (105) to rotate relative to the last support arm (107) about the second support arm pivot (175). Rotation of the second support arm (105) relative to the last support arm (107) is achieved preferably through the action of a second lifting mechanism (193) that preferably has a first end (194) and second end (192) and is pivotally attached at its first end (194) to the second support arm (105) at a position near to the first end (158) of the second support arm (105) and at its second end (192) at a position near to the first end (178) of the last support arm (107). The second lift mechanism (193) may be a hydraulic, pneumatic, screw-type, or other lift mechanism.

The last support arm (107) is rotationally connected at its second end (176) to a vehicle (109) at a position preferably relatively near the rear end (110) of the vehicle (109) at a last support arm pivot (179). The rotational connection allows the last support arm (107) to rotate relative to the vehicle (109) about the last support arm pivot (179). Rotation of the last support arm (107) relative to the vehicle (109) is achieved preferably through the action a last lifting mechanism (195) that preferably has a first end (198) and second end (196) and is pivotally attached at its first end (198) to the last support arm (107) at a position between the first end (178) and second end (176) thereof, and at its second end (196) to the vehicle (109) at a last lifting mechanism pivot (177) located at a position toward the front end (112) of the vehicle (109) relative to the last support arm pivot (179). The last lift mechanism (195) may be a hydraulic, pneumatic, screw-type, or other lift mechanism.

Generally, when the load handling system of the depicted embodiment is arranged to be carrying a load, that is, in the transit configuration as shown in FIG. 3, the first lifting mechanism (239) will be at some intermediate point of extension and the first length (237) of the first support arm (203) will be configured generally perpendicular to the second support arm (105) so that the vehicle, when loaded and in the transit position (FIG. 3), operates in essentially the same manner as a traditional, prior art HEMTT-LHS truck.

As is shown in the figures of the depicted embodiment, the support arms (203, 105, and 107) are generally serially disposed. From the connection between the first support arm (203) and the second support arm (105) at the first support arm pivot (235), to the connection between the last support arm (107) and the vehicle (109) at the last support arm pivot (179), each of the rotational connections between a support arm and a succeeding support arm in the series from the first support arm (203) to the last support arm (107), including the rotational connection of the last support arm (107) to the vehicle (109) at the last support arm pivot (179), are organized in succession along a path traversing successive support arms from pivot to pivot.

Each of the successive pivoting connections defines at least one axis of rotation about which the connector (101) may move during loading and unloading as the support arms move relative to one another about those pivoting connections. Generally there will be only one axis of rotation defined by any pivoting connection between support arms because the connection will be configured so as to only allow rotation about a single axis. It may be, however, that in another embodiment a particular rotational connection between support arms will allow for rotation about more than one axis. For instance, a connection may allow rotation about two axes orthogonal to one another. In another example, a ball-and-socket connection between two support arms would allow a nearly infinite number of axes of rotation between the two support arms.

For purposes of the present disclosure, a support arm is a portion of the LHS that is generally substantially rigid. A support arm may be flexible, however. Joints wholly encompassed by a support arm, that is, joints on either side of which lie portions of the same support arm, are generally rigid, not allowing for rotation about the joint. Rotation of a support arm is generally only allowed about joints or connections between distinct support arms.

It may be observed from the figures that in the depicted embodiment there are two direct connections between the LHS and the vehicle, one at the last lift mechanism pivot (177) and another at the last support arm pivot (179). In this embodiment these connections are at fixed positions with respect to the chassis of the vehicle (109); the connection being made either directly to the chassis itself, or indirectly to another piece of material attached thereto. Additionally, it may be observed that these connections do not become disconnected from the vehicle (109) during operation of the load handling system. While in the depicted embodiment the connections to the chassis are fixed, in another embodiment the connections may be movable relative to the chassis, but will not disconnect therefrom. That is, during operation of the depicted embodiment, the number of connections between the load handling system of the depicted embodiment and the vehicle chassis remains constant; there are no reversible connections made between the load handling system and the vehicle chassis during operation of the load handling system.

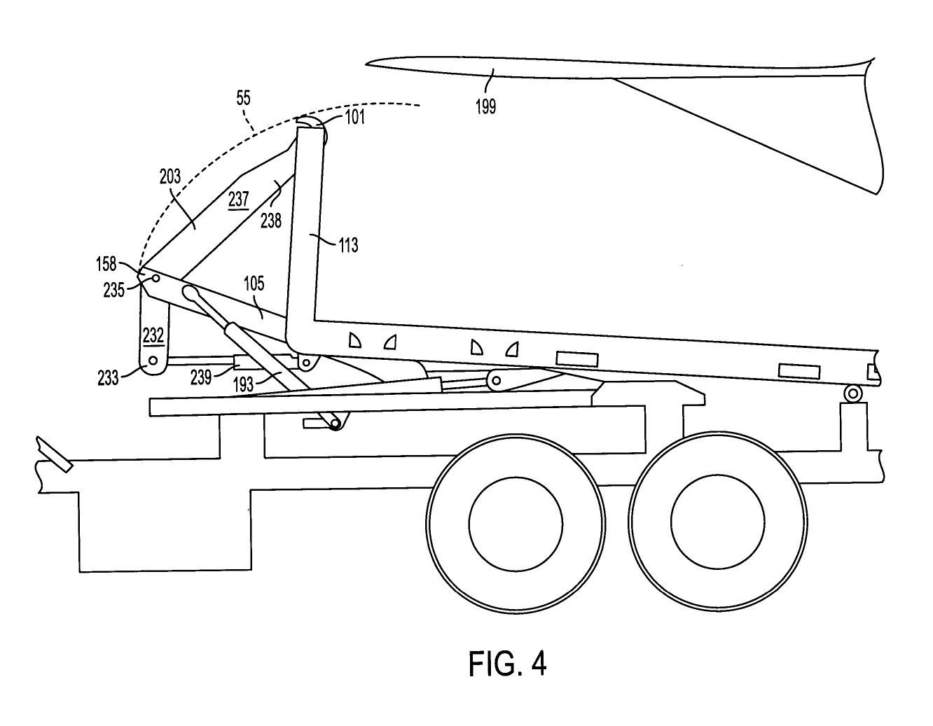

Examining the figures in numerical order shows how the depicted embodiment operates in a manner that requires less overhead clearance than the prior art HEMTT-LHS. Starting from the transit position shown in FIG. 3, during the initial phase of unloading, shown in FIG. 4, the second support arm (105) is raised by the second lift mechanism (193). The first lift mechanism (239) also operates during the initial phase of unloading, pushing on the second end (233) of the first support arm (203), causing the first length (237) of the first support arm (203) to rotate towards the second support arm (105) in a manner that reduces the angle between the first length (237) and the second support arm (105) from the approximately perpendicular starting configuration.

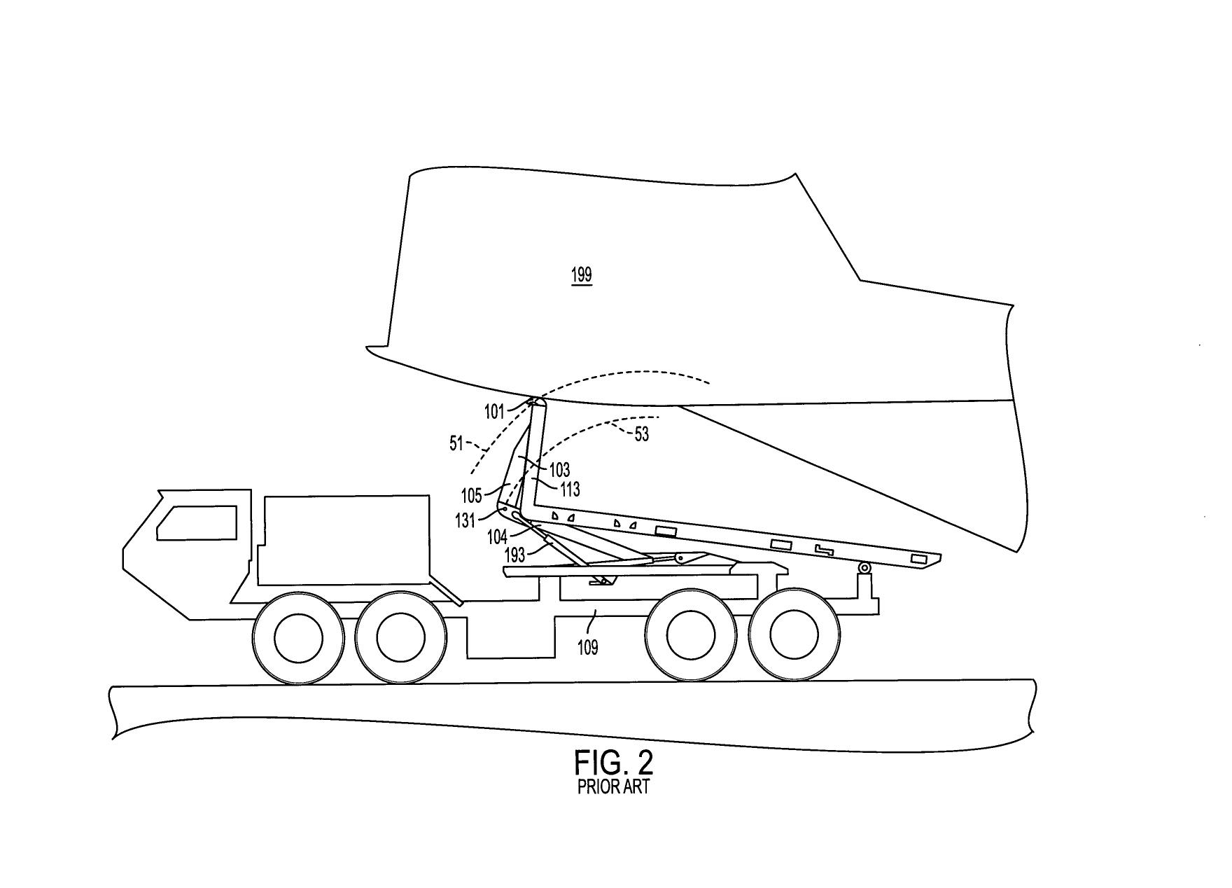

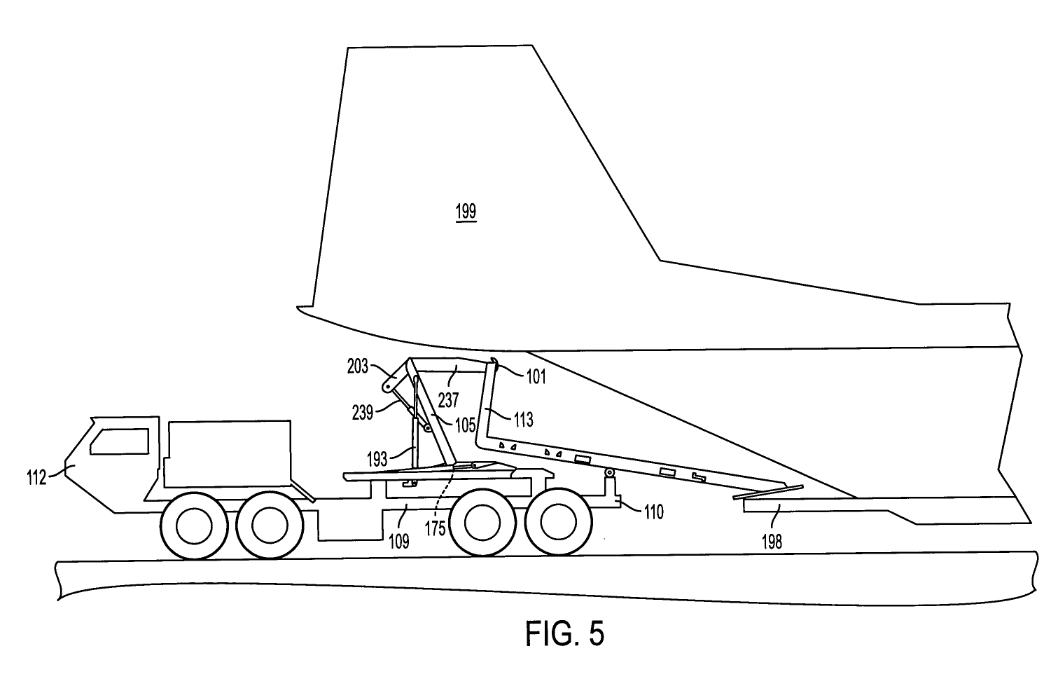

As unloading continues, as shown in FIG. 5, the second lift mechanism (193) continues to extend, rotating the second support arm (105) about the second support arm pivot (175), while the first lift mechanism (239) may or may not continue to extend, either maintaining a fixed-angle relationship between the first length (237) of the first support arm (203) and the second support arm (105) at less than ninety degrees if it ceases extending, or continuing to reduce the angle between the first length (237) and the second support arm (105). Considering the path of the hook (101) when comparing the prior art HEMTT-LHS and the depicted embodiment, the path of the hook in the depicted embodiment traverses a greater distance horizontally for each increment of elevation during the time that both the first lift mechanism (239) and second lift mechanism (193) are simultaneously extending. Further, in the depicted embodiment, the hook (101) is raised to lower total elevation as compared with the prior art HEMTT-LHS of the same dimension. In the prior art HEMTT-LHS, as shown in FIG. 2, due to the rigid, perpendicular configuration of the front support arm (105) and the relative proportions of each portion thereof, the hook (101) generally is raised above the highest elevation reached by the vertex (131) of the front support arm (105). The difference in elevation between the hook (or) and the vertex (131) is shown in FIG. 2 through a comparison of the path (51) of the hook (101) to the path (53) of the vertex (131). The vertex (131) of the front support arm (105) of the prior art HEMTT-LHS is an equivalent position to the first end (158) of the second support arm (105) of the depicted embodiment of the present invention. As shown of the depicted embodiment, by the dashed arc in FIG. 4, by decreasing the angle between the first support arm (203) and second support arm (105), the hook (101) may rise to an elevation no greater than the highest elevation of the first end (158) of the second support arm (105). The highest elevation of the hook, however, is dependent upon the configuration of the first support arm (203), the first lift mechanism (239), the second support arm (105), and the angle through which the first support arm (203) is rotated relative to the second support arm (105) during operation.

Also at this stage in the unloading process, as the load is being pushed off the rear end (110) of the vehicle (109), one will also see that the pallet (113) is not at as steep of an angle with respect to the vehicle chassis as it would be if the first support arm (203) were not caused to rotate toward the second support arm (105). Essentially, as compared to the prior art HEMTT-LHS, the load is being pushed off the vehicle in a more horizontal and less vertical manner so as to enable unloading underneath the overhead obstruction.

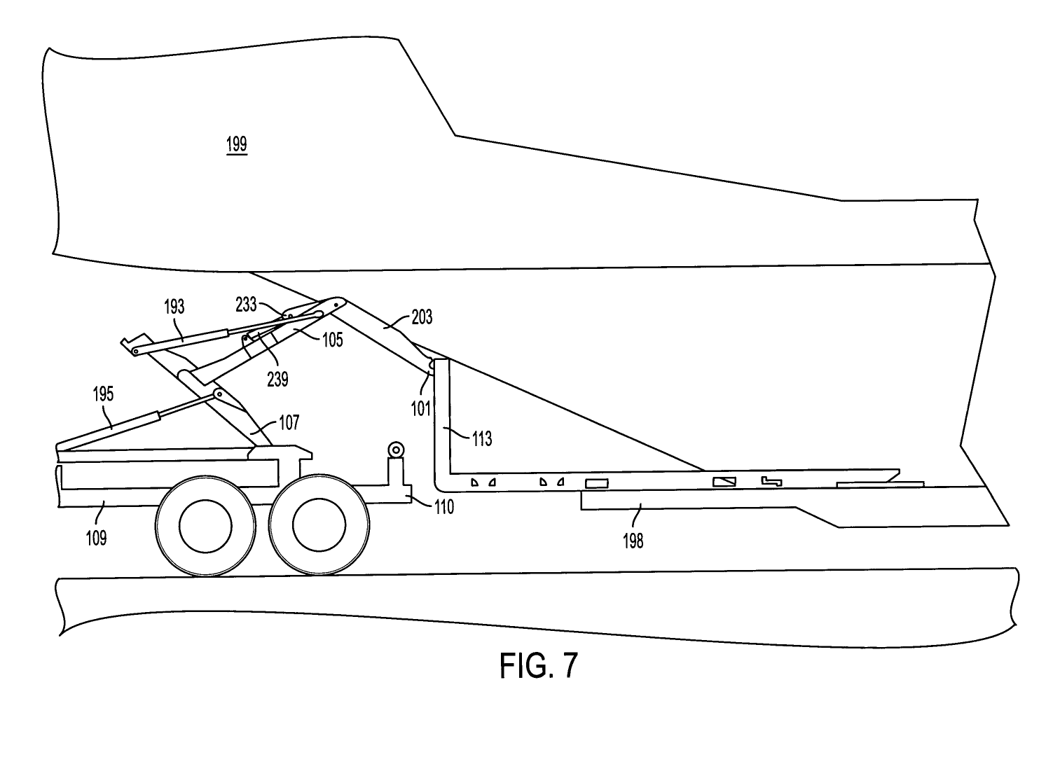

As shown in FIG. 6 and FIG. 7, to continue unloading, the second lift mechanism (193) continues to extend, continuing to rotate the second support arm (105) relative to the last support arm (107). Once the second support arm (105) has passed through the vertical position, the LHS has operated to avoid contact with the obstruction, the C-130 aircraft (199) protruding above the LHS, and the last lift mechanism (195) may begin to extend, rotating the last support arm (107) relative to the vehicle (109). Now, rotation of the last support arm (107) about the last support arm pivot (179) causes the horizontal displacement of the hook (101) to further increase, allowing the hook (101) and, therefore, the load to be moved further off the rear end (110) of the vehicle (109).

Once the first end (158) of the second support arm (105) has passed to a position toward the rear end (110) of the vehicle (109) relative to the last support arm pivot (179), as the last support arm (107) continues to rotate about the last support arm pivot (179) the load may begin to decrease in elevation, eventually allowing for unloading to an elevation lower than the transit position of the load on the vehicle (109). To avoid bumping the load onto the rear end (110) of the vehicle (109), however, at some point in the operation after the hook (101) has passed beneath the aircraft (199) the first lift mechanism (239) may begin to contract, reversing the original rotation of the first support arm (203) relative to the second support arm (105) and, thereby, increasing the angle between the first length (237) of the first support arm (203) and the second support arm (105) toward the perpendicular and possibly to greater angles. This increase in the angle between the first length (237) and the second support arm (105) may serve to maintain the elevation of the hook (101) and, therefore, of the load, allowing the load to move past the rear end (110) of the vehicle (109) without contacting the vehicle (109). A similar contracting action of the second lift mechanism (193) may be used to increase the angle of the second support arm (105) relative to the last support arm (107). This contracting action of the first lift mechanism (239) and second lift mechanism (193) may allow the load to be pushed further away from the rear of the vehicle while maintaining the elevation of the hook and, therefore, maintaining the elevation of the end of the load attached thereto. These lift mechanism actions may allow the load to avoid bumping the rear end (110) of the vehicle (109), as well as maintain a relatively constant angle with respect to the ground or, as in the depicted embodiment, with an aircraft deck (198), until the load reaches the horizontal displacement at which it is to be disengaged from the LHS, at which point the LHS can be made to lower the load completely onto the ground or aircraft deck (198) by continued extension of the last lift mechanism (195). In another embodiment, the movement of the first length (237) of the first support arm (203) through the perpendicular to angles greater than ninety degrees with respect to the second support arm (105) need not be used or even available.

At some point in the unloading process the load will be lowered completely onto the deck (198) of the aircraft (199) as shown in FIG. 7. From this position the LHS need extend no further because, if necessary, continued loading into the aircraft (199) can be accomplished by driving the vehicle (109) back toward the aircraft (199). To release the hook (101) from the load, now supported by the deck (198) of the aircraft, the hook (101) may be rotated downward away from the load by activation of either of the first lift mechanism (239) or second lift mechanism (193). In another situation, where the last support arm (107) has passed through a vertical position, the release of the load may be accomplished by actuation of the last lift mechanism (195) as well.

To move a load onto the vehicle (109) from the aircraft deck (198) the above steps could simply be reversed.

From this description and the included figures it should be clear that having an LHS comprising three serially disposed and pivotally connected support arms controllably driven to allow for independently changing the angle between each of the connected support arms allows for a load to be unloaded from a vehicle with less required overhead clearance than would be required by a prior art LHS of comparable dimensions. In an embodiment, therefore, the invention disclosed herein comprises an LHS having such a construction. The invention, however, is broader in scope than the depicted embodiment. Several examples follow of embodiments other than the one depicted.

While the above discussed figures depict the LHS on an HEMTT truck, one of ordinary skill in the art would understand that any vehicle currently utilizing an LHS or PLS system could have that system replaced with an LHS embodying the present invention. Further, an LHS embodying this invention could be added to any type of vehicle now in use or developed in the future and designed for carrying a load.

Other embodiments include variations from the depicted and described support arms. While the embodiment described in the figures provides for support arms that are generally linear in nature, this configuration is not necessary and the support arms encompassed by this invention could have any other appropriate shape. Additionally, the support arms may be forked, having substantially empty space between two or more generally parallel protruding portions. Or, any or all of the support arms may be replaced by multiple parallel support arms in a configuration equivalent to the single arm being replaced. Additionally, while the embodiment described in the figures has only one support arm that rises vertically from the vehicle in the transit position, there is no limit to the number of vertical support arms, nor is it necessary that there be any arm or portion thereof that rises vertically from the vehicle in the transit position.

Other alternate embodiments of the invention include variation from the depicted and described lift mechanisms. Any of the lift mechanisms described above may operate in conjunction with one or more lift mechanisms, especially lift mechanisms that are operationally equivalent. These additional lift mechanisms may be attached to the above described support arms at a position along the line delineating the transverse axis about which the above described lift mechanisms connect to and rotate relative to the labeled support arms, or additional lift mechanisms could be attached at other positions on the support arms. In an embodiment these lift mechanisms would be parallel, equivalent lift mechanisms displaced along the transverse axis relative to the support arm to which they attach. In alternative embodiments any or each of the support arms may be controlled by a separate lift mechanism or may be controlled by a power-take-off or similar structure from a primary lift mechanism, including a primary lift mechanism that is controlling another support arm.

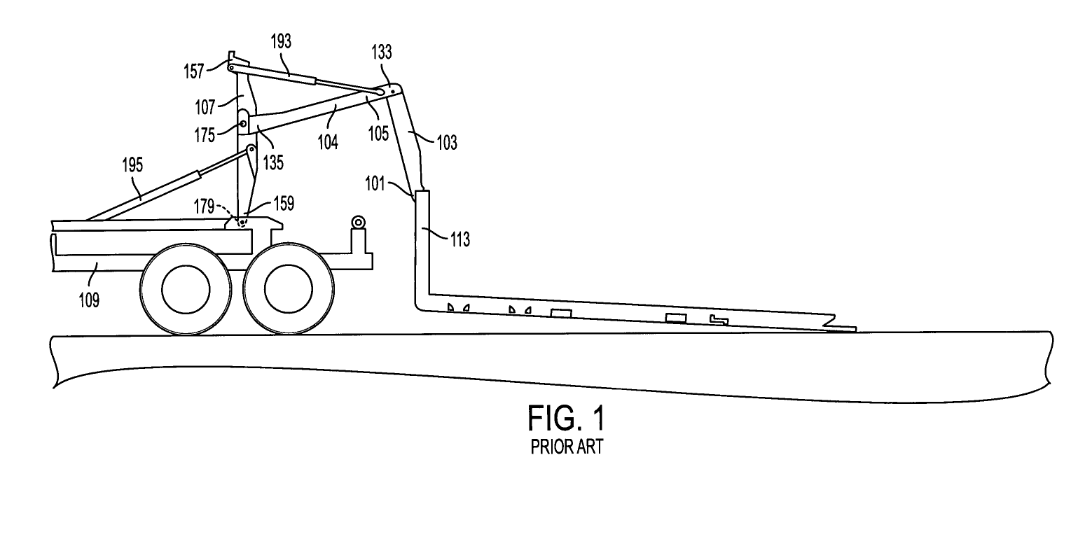

The load handling system described herein also need not be an entirely new system. As should be clear from comparison of the prior art HEMTT-LHS, shown in FIG. 1 and FIG. 2, with the embodiment of the present invention, shown in FIGS. 3-7, many of the components of an embodiment of the invention may be the same as components used by the prior art PLS and LHS systems. Therefore, embodiments of the invention also comprise a kit providing either or both, parts and instructions for allowing an existing prior art LHS to be converted to an embodiment of the present invention.

As compared with the detailed description of the operation of the depicted embodiment, one of ordinary skill in the art would also see that an LHS embodying the present invention could operate in the same manner as a traditional prior art LHS. This can be illustrated simply by imagining the embodiment depicted in the figures operating without actuating the first lift mechanism (239), and therefore operating as though the first support arm (203) and second support arm (105) were rigidly connected in a fixed-angle configuration of about ninety degrees.

Any of various embodiments may be preferred for a particular application because such a preferred embodiment may provide for more or less required overhead clearance for the loading and unloading operation than the embodiment depicted.

While the present invention has been disclosed in connection with certain preferred embodiments, this description should not be taken as limiting the invention to all of the provided details. Modifications and variations of the described embodiments may be made without departing from the scope and spirit of the invention. Various and multiple alternate embodiments are encompassed in the present invention disclosure as would be understood by one of ordinary skill in the art.

1. A load handling system for manipulating a load onto and off of a vehicle, said load handling system comprising:
a connector for connecting the load handling system to the load;
at least three axes about which the connector moves relative to the vehicle during loading and unloading; and
at least one support arm fixedly connected to the vehicle, wherein each of said at least one support arm fixedly connected to the vehicle remains connected to the vehicle throughout the loading and unloading process, and wherein none of said at least one support arm fixedly connected to the vehicle reversibly engages the vehicle as a prerequisite for enabling said connector for connecting the load handling system to the load to move about three axes relative to the vehicle during loading and unloading.

2. A load handling system of claim 1, wherein said connector for connecting the load handling system to the load includes a hook, a clamp, a strap, a chain, or a magnet.

3. A load handling system of claim 1 further comprising at least one lift mechanism.

4. A load handling system of claim 3, wherein each of said at least one lift mechanism includes a hydraulic actuator, a pneumatic actuator, or a screw-type actuator.

5. A load handling system of claim 3, wherein said connector for connecting the load handling system to the load includes a hook, a clamp, a strap, a chain, or a magnet.

6. A load handling system of claim 1 further comprising:
a first support arm having a first end and a second end, said first support arm attached to the connector for linking the load handling system to a load, said connector disposed near said first end of said first support arm;
a second support arm having a first end and a second end, said first end being pivotally connected to the first support arm at a point between the ends of said first support arm, said second end being pivotally connected to a last support arm;
a last support arm having a first and second end, said second end being pivotally connected to said vehicle, said last support arm being pivotally connected to the second support arm at a point on the last support arm between said first and second ends of said last support arm;
a first lift mechanism having a first end and a second end, the first end of said first lift mechanism being pivotally connected to the first support arm at a position near to the second end of said first support arm, and the second end of said first lift mechanism being pivotally connected to the second support arm at a position between the first and second end of the second support arm, said first lift mechanism being capable of rotating said first support arm with respect to said second support arm;
a second lift mechanism having a first end and a second end, the first end of said second lift mechanism being pivotally connected to the second support arm at a position near to the first end of said second support arm and the second end of said second lift mechanism being pivotally connected to the last support arm at a position near to the first end of the last support arm, said second lift mechanism being capable of rotating said second support arm with respect to said last support arm;
a last lift mechanism having a first end and a second end, the first end of said last lift mechanism being pivotally connected to the last support arm at a position between the first and second ends of said last support arm and the second end of said last lift mechanism being pivotally connected to said vehicle, said last lift mechanism being capable of rotating said last support arm with respect to said vehicle.

7. A load handling system of claim 6, wherein said connector for connecting the load handling system to the load includes a hook, a clamp, a strap, a chain, or a magnet.

8. A load handling system of claim 6 wherein each of said first, second, and last lift mechanisms includes a hydraulic actuator, a pneumatic actuator, or a screw-type actuator.

9. A load handling system of claim 1, wherein the vehicle is a Heavy Expanded Mobility Tactical Truck (HEMTT).

10. A vehicle for moving a load, said vehicle comprising
a front end;
a rear end; and
a load handling system for manipulating a load onto and off the vehicle, said load handling system comprising:
at least three support arms generally serially disposed so that there is a first support arm, a second support arm, and a last support arm, each of said support arms being pivotally connected with a support arm next adjacent in the series, said last support arm being pivotally connected to the vehicle;
wherein said load handling system has a transit configuration for carrying the load when the vehicle is in motion, said transit configuration being such that the pivotal connection between one of said at least three support arms and a next adjacent support arm closer in the series to the last support arm is at a position relative to the vehicle no closer to the rear end of the vehicle than is the position of the pivotal connection between said next adjacent support arm and the support arm that is next closer in the series to the last support arm as compared to said next adjacent support arm, the position of the pivotal connection between the next-to-the-last support arm and the last support arm being at a position relative to the vehicle no closer to the rear end of the vehicle than is the position of the pivotal connection between the last support arm and the vehicle.

11. A vehicle of claim 10 further comprising:
said load handling system further comprising:
a connector for connecting the load handling system to the load; and
at least three axes about which the connector moves relative to the vehicle during loading and unloading;
wherein said at least three axes correspond to pivotal connections between next adjacent support arms and to pivotal connections between a support arm and the vehicle, and wherein said transit configuration of the load handling system is such that said at least three axes are serially disposed such that a first axis that corresponds to the pivotal connection between one of the at least three support arms and the next adjacent support arm closer in the series to the last support arm has a pivotal-connection-crossing position that is no closer to the rear end of the vehicle than is the pivotal-connection-crossing position of a second axis corresponding to the pivotal connection between said next adjacent support arm and the support arm that is next closer in the series to the last support arm as compared to said next adjacent support arm, the pivotal-connection-crossing position of an axis corresponding to the pivotal connection between the next-to-the-last support arm and the last support arm being at a position relative to the vehicle no closer to the rear end of the vehicle than is the pivotal-connection-crossing position of an axis corresponding to the pivotal connection between the last support arm and the vehicle.

12. A vehicle of claim 10 further comprising:
a first support arm having a first end and a second end, said first support arm attached to the connector for linking the load handling system to a load, said connector disposed near said first end of said first support arm;
a second support arm having a first end and a second end, said first end being pivotally connected to the first support arm at a point between the ends of said first support arm, said second end being pivotally connected to a last support arm;
a last support arm having a first and second end, said second end being pivotally connected to said vehicle, said last support arm being pivotally connected to the second support arm at a point on the last support arm between said first and second ends of said last support arm;
a first lift mechanism having a first end and a second end, the first end of said first lift mechanism being pivotally connected to the first support arm at a position near to the second end of said first support arm, and the second end of said first lift mechanism being pivotally connected to the second support arm at a position between the first and second end of the second support arm, said first lift mechanism being capable of rotating said first support arm with respect to said second support arm;
a second lift mechanism having a first end and a second end, the first end of said second lift mechanism being pivotally connected to the second support arm at a position near to the first end of said second support arm and the second end of said second lift mechanism being pivotally connected to the last support arm at a position near to the first end of the last support arm, said second lift mechanism being capable of rotating said second support arm with respect to said last support arm;
a last lift mechanism having a first end and a second end, the first end of said last lift mechanism being pivotally connected to the last support arm at a position between the first and second end of said last support arm and the second end of said last lift mechanism being pivotally connected to said vehicle, said last lift mechanism being capable of rotating said last support arm with respect to said vehicle.

13. A vehicle of claim 12 wherein said connector for connecting the load handling system to the load includes a hook, a clamp, a strap, a chain, or a magnet.

14. A vehicle of claim 12 wherein each of said first, second, and last lift mechanisms includes a hydraulic actuator, a pneumatic actuator, or a screw-type actuator.

15. A kit for converting a vehicle having a load handling system that raises a load to a first lowest maximum elevation during loading and unloading to a vehicle having a reconfigured load handling system that raises said load to a second lowest maximum elevation during loading and unloading, said second lowest maximum elevation being lower than said first lowest maximum elevation, and wherein said reconfigured load handling system comprises:
a connector for connecting the load handling system to the load;
at least three axes about which the connector moves relative to the vehicle during loading and unloading; and
at least one support arm fixedly connected to the vehicle, wherein each of said at least one support arm fixedly connected to the vehicle remains connected to the vehicle throughout the loading and unloading process, and wherein none of said at least one support arm fixedly connected to the vehicle reversibly engages the vehicle as a prerequisite for enabling said connector for connecting the load handling system to the load to move about three axes relative to the vehicle during loading and unloading.

16. A kit of claim 15 wherein said improved load handling system further comprises:
a first support arm having a first end and a second end, said first support arm attached to the connector for linking the load handling system to a load, said connector disposed near said first end of said first support arm;
a second support arm having a first end and a second end, said first end being pivotally connected to the first support arm at a point between the ends of said first support arm, said second end being pivotally connected to a last support arm;
a last support arm having a first and second end, said second end being pivotally connected to said vehicle, said last support arm being pivotally connected to the second support arm at a point on the last support arm between said first and second ends of said last support arm;
a first lift mechanism having a first end and a second end, the first end of said first lift mechanism being pivotally connected to the first support arm at a position near to the second end of said first support arm, and the second end of said first lift mechanism being pivotally connected to the second support arm at a position between the first and second end of the second support arm, said first lift mechanism being capable of rotating said first support arm with respect to said second support arm;
a second lift mechanism having a first end and a second end, the first end of said second lift mechanism being pivotally connected to the second support arm at a position near to the first end of said second support arm and the second end of said second lift mechanism being pivotally connected to the last support arm at a position near to the first end of the last support arm, said second lift mechanism being capable of rotating said second support arm with respect to said last support arm;
a last lift mechanism having a first end and a second end, the first end of said last lift mechanism being pivotally connected to the last support arm at a position between the first and second end of said last support arm and the second end of said last lift mechanism being pivotally connected to said vehicle, said last lift mechanism being capable of rotating said last support arm with respect to said vehicle.

17. A method of manipulating a load with respect to a vehicle comprising:
providing a load handling system that comprises:
a connector for connecting the load handling system to the load;
at least three axes about which the connector moves relative to the vehicle during loading and unloading; and
at least one support arm fixedly connected to the vehicle, wherein each of said at least one support arm fixedly connected to the vehicle remains connected to the vehicle throughout the loading and unloading process, and wherein none of said at least one support arm fixedly connected to the vehicle reversibly engages the vehicle as a prerequisite for enabling said connector for connecting the load handling system to the load to move about three axes relative to the vehicle during loading and unloading; and
using said load handling system to manipulate said load connected to said connector.

18. A method of claim 17 wherein in the step of providing, said load handling system further comprises:
a first support arm having a first end and a second end, said first support arm attached to the connector for linking the load handling system to a load, said connector disposed near said first end of said first support arm;
a second support arm having a first end and a second end, said first end being pivotally connected to the first support arm at a point between the ends of said first support arm, said second end being pivotally connected to a last support arm;
a last support arm having a first and second end, said second end being pivotally connected to said vehicle, said last support arm being pivotally connected to the second support arm at a point on the last support arm between said first and second ends of said last support arm;
a first lift mechanism having a first end and a second end, the first end of said first lift mechanism being pivotally connected to the first support arm at a position near to the second end of said first support arm, and the second end of said first lift mechanism being pivotally connected to the second support arm at a position between the first and second end of the second support arm, said first lift mechanism being capable of rotating said first support arm with respect to said second support arm;
a second lift mechanism having a first end and a second end, the first end of said second lift mechanism being pivotally connected to the second support arm at a position near to the first end of said second support arm and the second end of said second lift mechanism being pivotally connected to the last support arm at a position near to the first end of the last support arm, said second lift mechanism being capable of rotating said second support arm with respect to said last support arm;
a last lift mechanism having a first end and a second end, the first end of said last lift mechanism being pivotally connected to the last support arm at a position between the first and second end of said last support arm and the second end of said last lift mechanism being pivotally connected to said vehicle, said last lift mechanism being capable of rotating said last support arm with respect to said vehicle.

19. The method of claim 17 wherein in the step of using, the load is moved from a vehicle into an aircraft.

20. The method of claim 19 wherein the load is moved directly from a vehicle into an aircraft.

21. The method of claim 17 wherein in the step of using, the load is moved from an aircraft into a vehicle.

22. The method of claim 21 wherein the load is moved directly from an aircraft into a vehicle.
